(19) United States
(12) Patent Application Publication
(10) Pub. No.: US 2024/0328243 A1
(43) Pub. Date: Oct. 3, 2024

(54) Antiballistic Window Retrofitting Apparatus and Method

(71) Applicant: DISRUPTIVE DEALINGS, LLC, SHERIDAN, WY (US)

(72) Inventor: John B. Adrain, Farmersville, TX (US)

(73) Assignee: DISRUPTIVE DEALINGS, LLC, SHERIDAN, WY (US)

(21) Appl. No.: 18/739,250

(22) Filed: Jun. 10, 2024

Related U.S. Application Data
(63) Continuation-in-part of application No. 16/761,098, filed on May 1, 2020, now Pat. No. 12,007,208.
(60) Provisional application No. 62/581,308, filed on Nov. 3, 2017.

(51) Int. Cl. E06B 5/10; E06B 3/677

(52) U.S. Cl. CPC E06B 5/10; E06B 3/677

(57) ABSTRACT

A system and method for retrofitting or otherwise improving installed windows to provide anti-ballistic properties to the existing windows by using a portable system for filling gaps in the windows with an anti-ballistic material that may or may not be cured. Also provided are different optional structural additions to the window that can be installed to improve the anti-ballistic properties of the window.

### CROSS-REFERENCES TO RELATED APPLICATIONS

This application is a continuation-in-part of U.S. Pat. No. 12,007,208 filed on May 1, 2020, which is a national stage application of PCT application PCT/US2018/059036 filed on Nov. 2, 2018, which claims the benefit of U.S. provisional application Ser. No. 62/581,308 filed on Nov. 3, 2017, all hereby incorporated herein by reference.

### BACKGROUND

Protecting buildings against ballistic projectiles is sometimes a concern, even in buildings that are already constructed and outfitted. Many buildings use multiple pane glass windows of various types, such as thermal windows, where a gap is provided between two or more panes of glass. This gap may be filled with air, an insulating gas, or even a vacuum. A system of converting such already installed windows to exhibit anti-ballistic properties (e.g., bulletproofing) without replacing the windows in an economical manner would be useful to add antiballistic features to existing buildings at minimal cost.

### SUMMARY

Provided are a plurality of example embodiments, including, but not limited to, a method that uses an apparatus to reconfigure existing multiple paned windows into anti-ballistic windows without removing or replacing the windows.

Also provided is a method of adapting an installed window to have anti-ballistic properties, comprising the steps of:
drilling one or more holes in the installed window or a frame of the installed window; and
pumping a fluid to add anti-ballistic properties to the installed window through the one or more holes into a gap between panes of transparent material in the installed window.

Subsequent to the pumping step, the installed window exhibits improved anti-ballistic properties.

Further provided is a method of adapting an installed window to have anti-ballistic properties, comprising the steps of:
drilling one or more holes in the installed window or a frame of the installed window;
pumping, using a portable pumping system, a fluid to add anti-ballistic properties to the installed window through the one or more holes into a gap between panes of transparent material in the installed window;
vibrating the installed window to enhance settling of the fluid into the gap between panes of transparent material in the installed window; and
sealing the drilled holes subsequent to the step of pumping the fluid.

Subsequent to the pumping step, the installed window exhibits improved anti-ballistic properties.

Also provided is a method of adapting an installed window to have anti-ballistic properties using a portable system comprising a pump and at least one tank of a fluid, the method comprising the steps of:
drilling one or more holes in the installed window or a frame of the installed window; and
pumping, using the portable system, the fluid to add anti-ballistic properties to the installed window through the one or more holes into a gap between panes of transparent material in the installed window.

Subsequent to the pumping step, the installed window exhibits improved anti-ballistic properties.

Further provided is a portable system for retrofitting an installed window to have anti-ballistic properties, such that might perform any of the methods provided hereinabove, the system comprising: a drilling subsystem to drill one or more holes in the installed window or a frame of the installed window; a tank for holding a fluid; and a pump and distribution system for transporting the fluid from the tank into a gap between panes of the installed windows through the drilled one or more holes.

Further provided is a method of adapting an installed window already installed in a window frame currently installed in a building, said method to provide added anti-ballistic properties to said window, said method comprising the steps of: connecting an apparatus configured to pump a fluid into a gap adjacent to a first pane of transparent material provided as part of said installed window; and said apparatus pumping the fluid into the gap while said window remains installed in said building, wherein said fluid is configured within said gap to maintain window transparency in the installed window with said fluid also being configured to add new anti-ballistic properties to the installed window.

Still further provided are any of the above systems further comprising a vibrating device configured to vibrate the installed window to enhance settling of the fluid into the gap between the panes of the window.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a schematic drawing showing a cross section of an installed window configured for adding antiballistic and/or tinting properties;

FIG. 2 is a schematic drawing of an example system configured to adapt an installed window to have antiballistic and/or tinting properties;

FIG. 3 is a schematic drawing of an example mobile platform for transporting a system such as provided in FIG. 2;

FIG. 4 is a schematic drawing of an example control system for controlling a tinting function of a window that has been adapted as provided hereon;

FIG. 5 is a schematic drawing of a cross section of an example window processed according to an example method described herein;

FIG. 6 is a schematic drawing of a cross section of an example window processed according to an example method described herein with added structure processed locally to improve anti-ballistic properties;

FIG. 7 is a schematic drawing of a cross section of an example additive window section that can be manufactured remotely;

FIG. 8 is a schematic drawing of a cross section of an example window processed according to an example method described herein with added remotely processed additive window section of FIG. 7 to improve anti-ballistic properties;

FIG. 9 is a schematic drawing of a cross section of another example window with added structure processed locally to improve anti-ballistic properties;

FIG. 10 is a schematic drawing of a cross section of another example window with added remotely processed additive window section of FIG. 7 to improve anti-ballistic properties; and

FIG. 11 is a schematic drawing of a cross section of another example window processed according to an example method described herein with alternative added structure processed locally to improve anti-ballistic properties;

### DETAILED DESCRIPTION OF THE EXAMPLE EMBODIMENTS

Various methodologies using particular equipment for retrofitting windows is provided.

Generally, existing windows utilizing multiple panes of glass with gaps between them (such as for thermal efficiency) that are installed in window frames are adapted to having anti-ballistic properties through the addition of strengthening or other anti-ballistic materials within the gaps between window panes. This can be accomplished, for example, by drilling holes through the window frames, or even through the windows themselves, or by grinding a channel in a side of a window pane or frame, and then pumping an additive fluid material into the gaps between the currently installed windows using a portable pumping system. The holes can be drilled using conventional drilling techniques, or even by using a LASER (e.g., using a femtosecond laser or other laser, especially if the glass is tempered), or an extremely hot poker, especially for putting holes in the glass pane itself. The additive material can preferably be a fluid in liquid or gel form put under pressure by using a pump and a hose and nozzle system to pump the fluid between the window panes through the drilled holes, where the fluid settles into and fills the gap. Holes can be placed strategically both for use in accepting the nozzles for receiving the fluid, and to allow air to escape to prevent voids in the window gaps.

A vibrating device might be put into contact with the window pane or the window frame in order to vibrate the panes of glass so that the fluid settles within the window gaps in a manner to fill all voids, in particular to permit the window to remain transparent. The vibrations can be provided by a rapidly vibrating tool, or by tapping the glass manually. The fluid is then cured either by heating the window panes, heating the fluid during the pumping process, using an infrared or ultraviolet cure process, or by a cure process that does not require any external curing procedure (e.g., by chemical reaction).

The fluid could be comprised of a transparent resin or gel. Currently, bullet-proof glass can be manufactured by placing layers of resin between layers of glass or other material. Similar resins could be utilized for this modification process. Liquified plexiglass might be utilized, as might materials such as magnesium aluminate, PERLUCOR, a polycarbonate (thermoplastic) (such as provided by Armormax, Makroclear, Cyrolon, Lexan or Tuffak), epoxies, or some other material. The fluid may have particles and/or fibers embedded therein that add additional anti-ballistic properties, such as any of the above listed materials, and other materials such as Spinel ceramics, transparent aluminum ceramics (Alon), or other materials such as aramid materials, for example.

Other materials that could be utilized are materials that remain in gel or liquid form and that need not be cured. Shear thickening fluids (STF) (e.g., a dilatant) that are transparent can be used to fill the gaps between window panes. Some of these materials harden (or thicken) upon impact or when dealt a sharp force or shear stress, and might be comprised of non-Newtonian fluids that that thicken in response to force (such as mixtures of cornstarch and water do, such as oobleck, which could be utilized). Examples of such materials have been disclosed recently but their composition are trade secrets. See www.sciencealert.com/liquid-armour-is-now-a-thing-and-it-stops-bullets-better-than-kevlar and www.telegraph.co.uk/news/uknews/defence/4862103/Military-to-use-new-gel-that-stops-bullets.html for examples. Furthermore, the anti-ballistic protection can be increased by suspending particles in the liquid that “lock” together upon impact creating a bond that improves the anti-ballistic capabilities of the liquid by spreading the force of the impact across a large area. Such liquids which are transparent in the static case could be utilized for adding anti-ballistic features to existing windows. Examples of such liquids are found online at www.popsci.com/technology/article/2010-07/british-designed-% E2%80%98bulletproof-custard % E2%80%99-better-kevlar-vest.

As another alternative, an anti-ballistic layer or film might be laminated to one or both of the window panes (in the interior and/or exterior of the building) to add further anti-ballistic capabilities. A layer or sheet of transparent material, such as magnesium aluminate, PERLUCOR, or ALON (a transparent aluminum-based ceramic material such as aluminum oxynitride), plexor, plexiglass, polycarbonate, or other material can be fixed to the window pane using a transparent resin or other material (such as polyvinyl butyral, polyurethane, Sentryglas or ethylene-vinyl acetate, for example) as a “glue” to hold the new layer in place. Alternatively, the new layer might only be fixed at the frame, and not to the glass pane itself. In some cases, multiple layers of anti-ballistic material might be used to provide additional protection. In other cases, gaps between the new layer and the original window can be filled with an anti-ballistic gel or liquid that may or may not be cured and that may be otherwise solidified or may remain as a gel or fluid.

Furthermore, a combination of the above processes could be utilized, such as by adding external layers of material as described above along with filling the window gaps with anti-ballistic materials, also described above, to improve the properties of the resulting window system. By providing more layers (e.g.,. window panes) and more filled gaps, additional protection from ballistic weapons can be provided, as desired.

Finally, the material used to fill the gaps in the window panes can be modified to provide electrochemical tinting capability in addition to the anti-ballistic properties. By adding LCD materials or other materials that can change state under electrical charge to turn the window from a transparent to a semi-transparent or even opaque state using an electrical control system, the window can be provided with tinting capabilities. Such features can be provided in “smart glass” or “smart tinting glass”. Such glass can utilize electrochromic, photochromic, thermochromic, suspended-particle, micro-blind and polymer-dispersed liquid-crystal devices to make buildings more climate adaptive.

For example, suspended-particle devices (SPDs), rod-like nano-scale particles can be suspended in the liquid that is to be placed between two pieces of glass or plastic panes in an existing window system, along with a control system that provides a voltage to change the orientation of the particles to block light. As an alternative, electrochemical additive can be provided that changes its opacity based on application of a voltage can also be used.

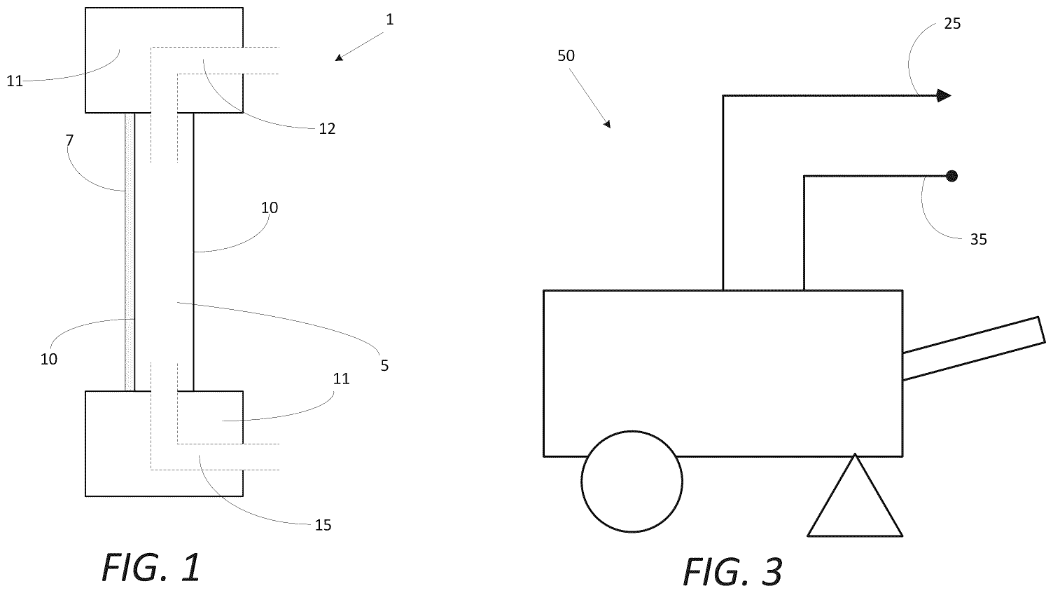

The gap filling process could be used to “retrofit” existing window systems in already installed windows, such as in skyscrapers or even in single family homes, schools, offices, government buildings, etc. As shown in the cross section of a window 1 in FIG. 1, upper holes 12 are drilled in a top leg of the frame 11 of the window 1, and lower holes 15 are drilled in a bottom leg of the frame 11. Alternatively, holes can be drilled in various other locations of the window pane(s) and/or window frame (s), such as on side portions or in the middle of a pane. The holes should provide access into gaps between window panes of multiple paned window systems, such a thermo pane windows. In some situations, holes may be drilled in a manner that is first horizontal into a frame 11, that then transitions vertically to enter the gap 5 between window panes, as shown by the dotted lines of the angled holes 12, 15 of the example of FIG. 1. Alternatively, the holes might be drilled directly into the window pane(s) itself.

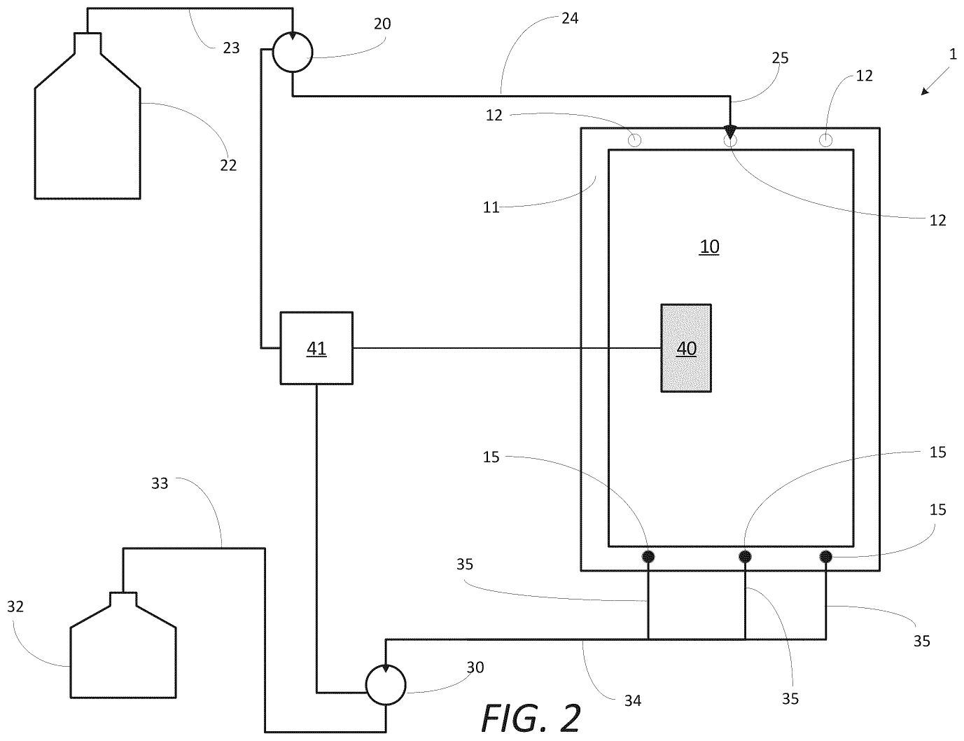

As shown in FIG. 2, the window 5 is to be retrofitted. A tank 22 is provided that holds an anti-ballistic fluid in a manner that facilitates application, such as by heating the fluid into a flowing liquid, or forming the liquid with segregated constituents that only cure when mixed by the pumping system. The system has a pump 20 connected to the tank 22 via a hose 23. The pump 20 pumps the one or more constituents through a hose 24 to a nozzle 25 that is inserted into one or more upper drill holes 12 provided in the window frame 11. Other upper drill holes 12 may or may not be used as fill points as well, or for gas escape purposes. The nozzle 25 may have a curved end or be comprised of a flexible tube so that the end of the nozzle enters the gap between the windows. The curve of the nozzle 25 should follow the curve of the drilled holes, if such holes are being utilized.

The fluid is then pumped by the pump 20 from the tank 22 (with an optional mixer if the fluid is comprised of constituent components) into the window gaps between the panes 10 under pressure to fill the gaps. Vibrating devices 40 powered by a power source 41 or manually operated can be provided on the window panes 10 to aid in the settling of the fluid, which will “fall” and settle into the window gaps, with any air (or other gas) bubbles present in the gaps between the panes being released as the fluid completely flows into the gaps. If desired, heating devices separate from, or incorporated within, the vibrating devices might be used to heat the window panes to aid in the fluid flow, and/or aid in curing the fluid. The glass may be vibrated by manually tapping the glass as well to aid settlement of the fluid.

A vacuum device comprising a pump 30, receiving tank 32, hoses 33, 34, and nozzles 17 could also be provided to help remove the air pockets and help “pull” the fluid into the gaps using lower drilled holes 15 drilled in a bottom of the window frame 11. Such a device can provide a suction source attached to the lower drilled holes 15, such as by using the nozzles 35 or other device to enter or cover the lower drilled holes 15 to evacuate the air in the window gaps to help remove the air gaps and help cause the fluid to fully flow into and fill the gaps between the window panes.

Care should be exercised to avoid the introduction of bubbles into the fluid, which could interfere with window transparency. Any bubbles might be removed by heating the fluid to thin it out, vibrating the panes (e.g., by manually tapping the panes or using a vibrating device), or other means.

Once the gap between the window panes has been substantially or fully filled with the fluid, the lower drilled holes 15 may be temporarily or permanently plugged, covered, taped over, or otherwise sealed. The same may be done to the upper drilled holes 12, if desired. Alternatively, the cured fluid may seal the holes. The fluid in the gap may then be heated (such as by using external heating devices such a heat guns, infrared heaters, heating pads, or other heating devices), or exposed to ultraviolet light, or some other means of curing the fluid, if a curable fluid is used for filling the window gaps.

In the case where the fluid will remain as a liquid or gel in the gaps without being cured, it may be that no further treatment of the window is needed once the gap is fully filled with the fluid. In this case, the lower holes, if present, should be filled using a plug or glue or other material to avoid the fluid from leaking from between the window panes. The same may be done with the upper drilled holes as well. In some cases, a small air gap may be left at the top of the window gap between the panes to allow for expansion of the fluid due to temperature changes, whether cured or not.

Alternatively, or additionally, a sheet of material 7 may be applied to one or both of the exposed window panes 10 such as by using an adhesive to adhere the sheet 7 to the window pane 10, or otherwise fixing the sheet in place by connection to the window frame(s), as shown in FIG. 1. This sheet 7 may be a layer of plexiglass or a lamination of plexiglass and glass or another material (such as discussed hereinabove) that may strengthen the resulting window to provide further protection against ballistic objects such as bullets. This sheet may prevent shattering of the glass in case of impact by a ballistic object, or it may flatten the object to make stopping it more effective. In some cases, the additional layer may be provided with a pocket between this new layer and the original window which may be filled with anti-ballistic material as discussed above.

In some cases, the window may be held in place using a holding device, such as might utilize suction cups or magnets on one or both sides of the window, especially in situations where the window may first be removed from the frame for treatment before being put back in place, or where treatment of the window may temporarily weaken the frame of the window thereby desiring help in holding the window in place.

Note that the components of the apparatus used to pump the fluid into the windows might be provided in a mobile device 50 as shown in FIG. 3, such as a cart, truck, vehicle, or other device. Such a device might have the tanks, heating equipment, hose and reel to wind the hose, and one or more nozzles 25, 35 all incorporated into the mobile device 50. The device might be operated within the building, or outside of the building, with the respective drilled holes being provided inside or outside, respectively. Some parts of the device may be kept outside the building, such as tanks for holding large quantities of the fluid(s) used to fill the gap. The mobile apparatus may have wheels or a pully system to ease its transport and use, and may have a self-contained power supply (such as operating using a fuel and hydraulic/pneumatic system), or might be electrically driven using batteries or an external power supply. The device 50 may be towed to location, and may be able to be transported up freight elevators, for example. The device 50 may also be provided with an engine or motor to make it easier to transport.

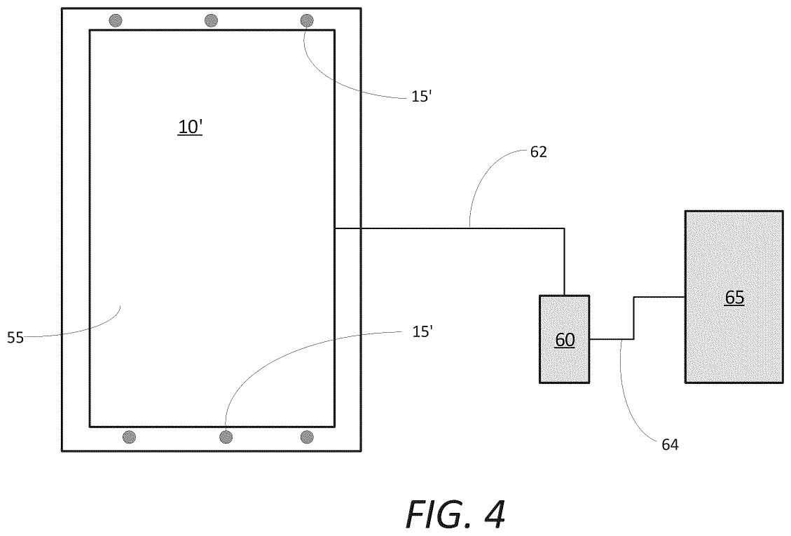

FIG. 4 shows a window that has been retrofitted to include tinting capabilities where the retrofitted window 10′ is filled with an anti-ballistic material 55 that has tinting capabilities by providing a voltage from a voltage driving device 60 via electrical connection 62 in electrical communication with the material 55. The voltage driving device 60 may be controlled by a room or building control system 65 via a communication bus 64, for example. In this way, the window 10′ can be provided with both anti-ballistic properties and tinting properties by using a retrofitting process to adapt existing windows to add these features without replacing the windows.

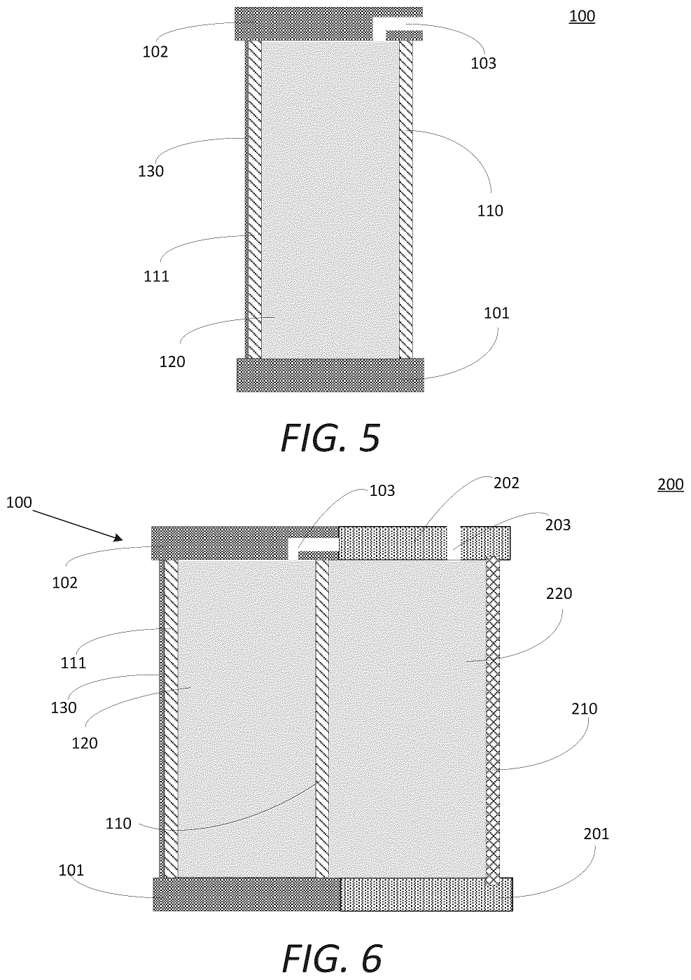

FIG. 5 shows a cross section of an example result of a modified, retrofitted window system 100, where existing window panes 110, 111, installed in a window frame 101, 102, has a gap 120 filled with an anti-ballistic material. Drilled hole 103 was used to introduce the fluid forming the anti-ballistic material prior to curing.

Optional film layer 130 can be added to the window system 100 (on an interior or exterior window pane, or both) to provide additional desired features, including improving the anti-ballistic properties of the system 100, improving thermal properties, adding heat resistance properties, or any combination of these improvements. Such a film layer can be added to any of the window systems described herein, including to already installed window systems.

Note that these film layers 130 can provide any of a number of desired features, such as anti-ballistic properties, fire resistance properties, or thermal insulating properties (such as by reflecting infrared rays). Such films may prevent glass breakage due to blunt impact, fire, or other trauma. Anti-ballistic properties for window systems may be enhance by using a film that flattens the point of a ballistic projectile such as a bullet, improving the anti-ballistic properties of other parts of the treated window by better dissipating the kinetic energy of the projectile.

Such films can be comprised of polyurethane and/or polyethylene terephthalate layers for anti-ballistic and/or strengthening properties, and/or insulating or heat blocking materials. Tinting films can also be used. These films can be of any desired structure that preserves window transparency (such as the films discussed elsewhere hereinabove).

As a further option, an existing installed window can have an additional window panel (or other transparent panel) system installed adjacent to the previously installed window panes to add additional protection. This additional pane may be added in the interior of the building, or on the exterior, or both. Such an additional window pane(s) may be comprised of a plate of glass, plexiglass, fire rated glass, ceramic glass, or other types of transparent panels or similar structures.

In this additive situation, the already installed existing windows may be treated as discussed above, with the additional panel installed and also treated by filling the gap between the new window panel and the existing window panes with the anti-ballistic fluid described herein. In this situation, additional anti-ballistic capabilities are added by using the additional gap(s) created by adding the new window pane(s), and/or by antiballistic properties of the newly added panel(s).

FIG. 5 shows an example cross section of a window system 200 where the window system 100 is filled with the anti-ballistic material as described above, but where additional structure is added to improve the anti-ballistic properties of the system 200. An additional window pane (panel) 210 is installed in place adjacent to the retrofitted system 100 using framing parts 201, 202. Hole 203 is used to fill the newly created gap 220 with additional, or different, anti-ballistic material fluid for curing in place after the new window and frame were installed in place.

Alternatively, a window structure may be assembled elsewhere, such as in a factory or on-site, where a pair of window panes in a frame are provided with an anti-ballistic material as discussed herein is provided between the windows, already cured for installation as a unit adjacent to an existing already installed window system.

Note that in such an alternative, the new window pane may be provided already filled with an anti-ballistic material at the factory by using double panels of transparent material (e.g., glass, plexiglass, plastic, laminated panels, etc.) with the gap in between filed with the anti-ballistic fluid/gel material installed and cured at a factory, with the new pane then mechanically installed adjacent to the existing installed window, which may include a new frame for holding the added panels together, and to the existing window structure. The frames of this additive structure can be made of any suitable material, such as steel alloys, aluminum alloys, composites, plastics, etc. It may be desirable to match the new frames to the current window frame designs, or otherwise match the aesthetics of the building by painting, or otherwise decorating the new frames and window systems.

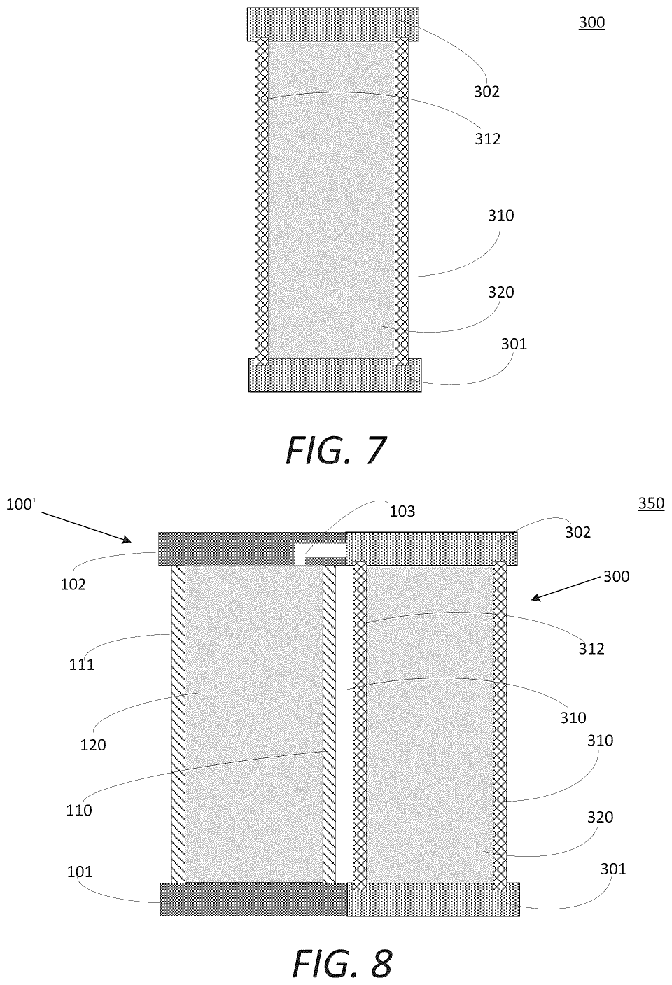

FIG. 7 shows a cross section of such a pre-built system 300, having a pair of window frames 310, 312 inserted into a frame having parts 301, 302 (and optional side parts not shown), fully or partly sealing the gap 320 that is filled with an anti-ballistic material such as described herein. Note that in some situations, the pane 312 may be optionally left out, with only a single pane 310 and framing material holding the anti-ballistic material in place.

The system 300 is to be cured and assembled remotely (or on site if desired), and then installed into an existing window frame 100′ as shown in FIG. 8 to form a system 350 that provides better anti-ballistic performance than the simpler system of FIG. 5. Appropriate installation and mounting hardware will be provided as needed to secure the manufactured system 300 to the already installed existing system 100′ using known or new installation techniques. Additional structure may be added to accommodate the weight of the new system 300, where needed.

Note that a new gap 310 may be formed in the system 350, which may be filled with additional anti-ballistic material, or with a gas or other substance to provide improved insulation properties for energy efficiency, for example. Alternatively, the gap 310 may be kept empty (e.g., having ambient air).

As another alternative, the existing windows may not be treated as described herein, but only a gap between a newly added window panel or pane and the existing installed window will be filled with an anti-ballistic fluid as described herein. This may occur where the existing windows are not appropriate for using the disclosed process to fill a gap, where the gap is too small (or non-existent), or where thermal properties or structural properties are not conducive to retrofitting the existing window frames. In this case, a new window panel or pane added to the existing window structure (as described herein) can be utilized to overcome any or all of these problems and still provide anti-ballistic protection to existing window systems already installed in a building.

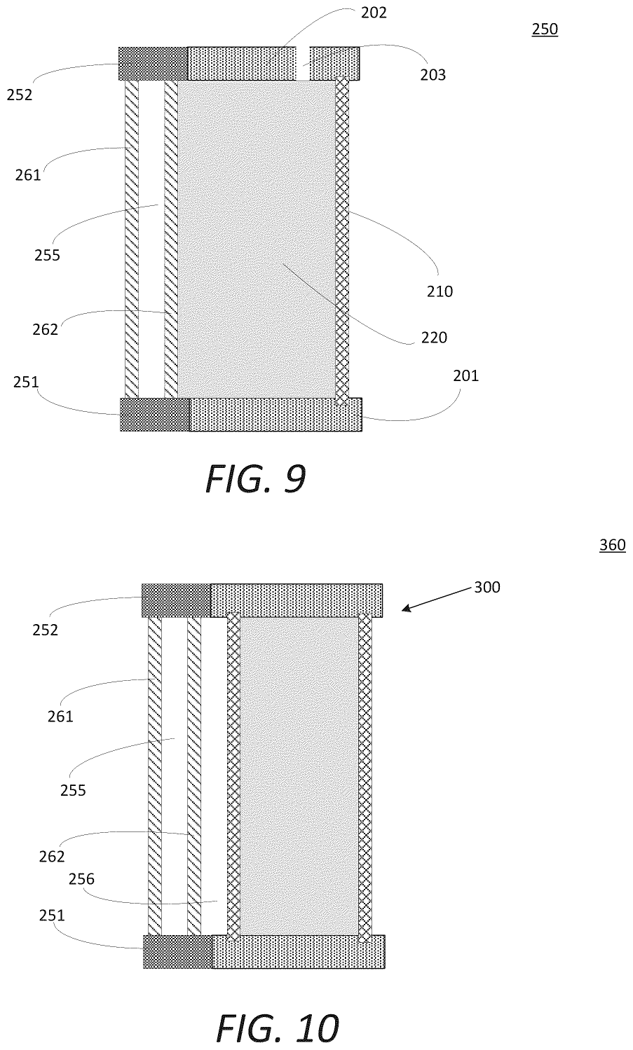

FIG. 9 shows an example system 250 where new structures are added, similar to as described for FIG. 6, but the existing already installed window system is not modified with any new fluid. Hence, existing and already installed panes 261, 262 in frame parts 251, 252 leave their gap 255 unmodified. Rather, new pane 210 is installed with frame parts 201, 202 (with additional side frame parts, where desired), and an anti-ballistic fluid is introduced into the gap 220 via hole 203 in a manner such as discussed herein, to provide anti-ballistic protection for the system 250.

Alternatively, the remotely manufactured (or on-site manufactured) unit 300 of FIG. 7 may be added to an unmodified window system as described for FIG. 9, as shown in FIG. 10 to form an anti-ballistic system 360.

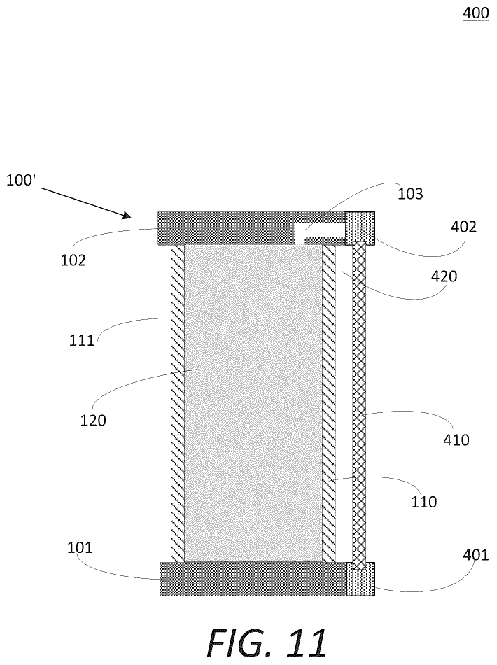

FIG. 11 shows another alternative system where the retrofitted modification 100′ as shown in FIG. 5 (but shown without the optional film 130) is further modified by adding an additional window panel 410 along with frame elements 401, 402, installed adjacent to the modified system 100′, forming gap 420 which can be treated as discussed for FIG. 8, hereinabove. In this case, the new panel might be provided of bullet resistant (or bullet proof) glass, or some other material providing desirable properties, but adding much less mass than the solutions of FIGS. 6 and 8, potentially avoiding the need of reinforcing the structure of the building.

Depending on the needs, any combination of the above modifications can be used to best improve the properties of the existing building window systems, as desired. Note that any of the added window panes utilized in any of the above improvements can be of any desired transparent window glass or plastic (such as Plexiglas). Bullet and/or fire resistant glass, plastics, ceramics, or any other material can be utilized as desired. In some cases, the gaps may be filled with fire resistant or thermally insulating material, rather than anti-ballistic material, to provide additional desired properties. For example, the embodiments of FIGS. 6 and 8 might utilize anti-ballistic material in one of the shown gaps, and fire resistant and/or thermal insulating material in the other gap. Or the gap filling material may be designed to exhibit any combination of anti-ballistic, fire resistant, and thermal insulating properties.

Furthermore, where used, these additional added panes and/or additional window systems can be installed inside the building (e.g., in the room where the window is located), or outside of the building, as desired. If the window system be modified is between rooms, either or both sides of the window system can be modified. One side might be modified differently than the other side, using any combination of the modifications discussed herein.

Note further that additional anti-ballistic properties can be provided by combining one or more of the above window retrofitting systems with bullet resistant retractable blinds, such as disclosed in U.S. Pat. No. 11,561,070 (issued on Jan. 24, 2023), and incorporated herein by reference in its entirety. By combining the blinds (or other barriers) of the '070 patent with any of the solutions described herein, improved ballistic protection can be provided up to and including NIJ certification Level IIA, Level II, Level IIIA, Level III and Level IV. Any of the embodiments disclosed herein can be tested and certified to any of those levels depending on the anti-ballistic protection that is provided by that embodiment.

Also note that the additional panes might include hinges or other movable features to allow for ingress/egress through the windows, especially where existing windows already offer this capability. Another alternative is to remove the existing installed window, treat it locally to add the fluid in its gap, and then re-install the window. A still other alternative is to take the removed window to a central location for treatment (such as a factory or local work area), and then returning it and re-installing it.

Finally, this process can be utilized to treat windows (or parts thereof) prior to their being installed in place rather than retrofitting them. For example, replacement thermal windows, which might typically contain a gas or vacuum between panes of glass, might instead be provided with the gaps being filled with ballistic resistant materials and/or tinting materials, as discussed herein, which can then be used to replace the panes of existing window structures while providing anti-ballistic protection. These techniques might also be utilized in new construction, not just for retrofitting existing structures.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of adapting an installed window already installed in a window frame currently installed in a building, said method to provide added anti-ballistic properties to said window, said method comprising the steps of:
connecting an apparatus configured to pump a fluid into a gap adjacent to a first pane of transparent material provided as part of said installed window; and
said apparatus pumping the fluid into the gap while said window remains installed in said building, wherein
said fluid is configured within said gap to maintain window transparency in the installed window with said fluid also being configured to add new anti-ballistic properties to the installed window.

2. The method of claim 1, wherein said gap is formed by a second pane of transparent material provided as part of said installed window next to said first pane of transparent material.

3. The method of claim 2, wherein said first pane of transparent material is comprised of a glass material.

4. The method of claim 2, further comprising a step of drilling a hole through said installed window into said gap for receiving said fluid therethrough.

5. The method of claim 2, wherein, subsequent to said pumping step, said fluid is cured within said gap to exhibit said transparency and said new anti-ballistic properties.

6. The method of claim 1, wherein, subsequent to said pumping step, said fluid is cured within said gap to exhibit said transparency and said new anti-ballistic properties.

7. The method of claim 1, wherein, subsequent to said pumping step, said fluid remains a fluid or gel within said gap to exhibit said transparency and said new anti-ballistic properties.

8. The method of claim 1, wherein said first pane of transparent material is comprised of a glass material.

9. The method of claim 1, further comprising the step of installing a second pane of transparent material next to said first pane of transparent material to form said gap.

10. The method of claim 9, wherein said second pane of transparent material is configured to provide anti-ballistic properties better than said first pane of transparent material.

11. The method of claim 1, further comprising the step of vibrating the installed window to enhance settling of the fluid into said gap.

12. The method of claim 1, wherein said apparatus is comprised of a portable pumping system that is transported to the building having the installed window.

13. The method of claim 1, wherein said fluid is comprised of one or more of a resin, liquified plexiglass, magnesium aluminate, PERLUCOR, a polycarbonate, an epoxy, and/or a fluid that thickens under shear force.

14. The method of claim 1, wherein said fluid includes a substance that provides controllable tinting capability for the installed window.

15. A method of adapting an installed window already installed in a window frame currently installed in a building, said method to provide added anti-ballistic properties to said window, said method comprising the steps of:
forming a hole into a gap between two panes of transparent material provided as part of said already installed window;
connecting an apparatus configured to pump a fluid into the gap through the hole; and
said apparatus pumping the fluid into the gap between said two panes while said window remains installed in said building, wherein
said fluid is cured within said gap to maintain window transparency in the installed window with said cured fluid being configured to add new anti-ballistic properties to the installed window.

16. The method of claim 15, wherein one or both of said first pane of transparent material and/or said second pane of transparent material is comprised of a glass material.

17. The method of claim 15, further comprising the step of installing a new layer of transparent material adjacent to said already installed window to provide additional anti-ballistic properties.

18. The method of claim 17, where said new layer is a film applied to one or both of said first pane of transparent material and/or said second pane of transparent material.

19. The method of claim 17, where said new layer is a third pane of transparent material.

20. The method of claim 19, where said third pane of transparent material forms a second gap that is filled with a transparent anti-ballistic material.

21. The method of claim 15, further comprising the step of drilling at least one gas escape hole in the installed window or the window frame of the installed window to allow gas to escape from the gap between panes of transparent material in the installed window during the pumping step.

22. A method of adapting an installed window already installed in a window frame currently installed in a building, said method to provide added anti-ballistic properties to said window, said method comprising the steps of:
Transporting a portable pumping system with an anti-ballistic fluid to the building having the installed window;
forming a hole into a gap between two panes of transparent material provided as part of said already installed window;
connecting the portable pumping system to the installed window at the hole; and
using the portable pumping system to pump the fluid into the gap between said two panes while said window remains installed in said building, wherein
said fluid is cured within said gap to maintain window transparency in the installed window with said cured fluid being configured to add new anti-ballistic properties to the installed window.
